(19) United States
(12) Patent Application Publication
(10) Pub. No.: US 2007/0111767 A1
(43) Pub. Date: May 17, 2007

(54) Method and apparatus for activity analysis

(75) Inventors: Marc F. Brown, Hayward, CA (US); Robert J. Van Scoy, Kensington, CA (US)

Correspondence Address: JOHNSON & STAINBROOK, LLP, 412 AVIATION BOULEVARD, SUITE H, SANTA ROSA, CA, 95403, US

(73) Assignee: INPRACTIS CORPORATION, INC., Hayward, CA (US)

(21) Appl. No.: 10/561,586

(22) PCT Filed: Jun. 21, 2004
(86) PCT No.: PCT/US04/19970

§ 371 Date: Dec. 19, 2005

Related U.S. Application Data
(60) Provisional application No. 60/480,094, filed on Jun. 20, 2003.

(51) Int. Cl. A63F 13/00; A63B 69/36; A63B 69/00

(52) U.S. Cl. 463/1; 473/422; 473/219

(57) ABSTRACT

A system and method for recording an individual performing an activity such as a golf swing includes a kiosk structure with an easy to use intelligent user interface to allow the individual to use the recording to analyze his or her own performance. The system accommodates input from multiple cameras to allow the playback of different views of the activity without the need to reposition the capture portion of the system in a different location, and can correct or partially correct the images that contain conventional distortion from fish-eye or other lenses that are used to provide close-up images, thereby allowing the use of the system in the spaces of existing facilities. The system may include an array microphone in the kiosk to detect the hit of the target ball while rejecting hits from adjacent stalls, which enables the system to identify and synchronize, at the point of impact, multiple video images of the same swing or of different swings. The system can employ any of a variety of conventional payment systems to allow it to integrate into the operations of the facility in which it will be used. The system can advertise and integrate with other facility operations to allow it to direct business to a professional or other operation of the facility.

### BACKGROUND OF THE INVENTION

1. Technical Field

The present invention is related to a computer video system and software for activity analysis, and more specifically to an improved video system for analyzing sports skills such as a golf swing.

2. Background Art

Many individuals perform activities for which a proper technique can improve their performance of that activity. For example, golfers use a swing to hit the ball, and employing a proper technique can improve the accuracy, distance, or both, of each shot. Baseball players employ any number of swings, pitches, a catches or other activities, for which proper technique can improve their performance. Tennis players employ a serve or a swing, for which proper technique can improve performance.

A professional, such as a coach or a manager or expert performer can watch the individual, and explain the deficiencies of the individual's technique when compared with a proper technique. However, this approach suffers from several drawbacks. First, the number of professionals or coaches that are effective at assisting others in this manner is only a small subset of the number of individuals performing the activity. This means that the individual may not receive sufficient time with the professional or coach to sufficiently improve. In addition, the use of a professional, coach or other similar expert may be more expensive than is desirable, particularly for amateur players who may not be able to economically justify the high cost of professional coaching in the same manner as a professional. Furthermore, when a professional is used to identify problems with the individual's technique, the individual can only hear a description of the deficiency, and cannot see the problem.

Video systems have been offered for purchase that allow a golf professional to record the performance of a golf swing for an individual. The golf professional then uses the video system to illustrate the individual's deficiencies. Although this technique can allow a user to see the deficiency, it still suffers from the requirement of a golf professional, with the associated expense and limited availability.

Although having individual users purchase video capture systems would avoid the prior problem, it would cause still other problems. Although such systems allow a professional to highlight deficiencies, the user of the system must be trained to spot them, and then trained to use the system, all of which could take more time and expense than simply hiring a professional who uses such a system. In addition, such systems have to be purchased at a significant expense, and the expense can be more than it would cost to hire the professional. In addition, if the user purchases the video capture system and then attempts to use it at a facility in which the activity is performed (such as a golf course driving range), the user would have to set up and take down the system each time he or she wishes to use it to avoid vandalism or theft. This cost and trouble inhibits individuals from purchasing such systems and using them at such facilities.

Another potential manner in which these systems could be used would be to rent them to the public at the facilities at which the activity is typically performed, such as a golf course driving range. However, as noted above, such systems are not rented to individuals without the use of a professional because the training required to use such systems and identify deficiencies adds more overhead than an occasional user such as an amateur player would find desirable.

Even if such problems could be avoided, which they have not, such systems have not been rented to the public by facilities frequented by amateur players because the professional or the golf course management may fear a loss in revenue from the professional's services.

If these problems could be solved, which thus far, they have not, other problems with renting such video systems to amateur users would remain to limit their usefulness. For example, such existing systems are designed to allow the connection of only a single camera, so that analysis from different angles requires the user to move the camera, test its location, and then try to mentally match the images from one performance of the activity to another so that the images may be used in conjunction, a process that would take too much time and effort compared with the value obtained.

The management of such facilities may not find the existing systems convenient to purchase and rent out to users of that facility. Conventional systems do not lend themselves to rental because they have no way to enforce payment that is convenient to such a facility. If a payment system was adapted for use with such a system, it would be yet another payment system that the facility would have to manage and maintain, an administrative difficulty. Furthermore, the other problems noted above could apply to a rental situation, such as the daily set up and take down of the equipment to avoid theft or vandalism.

Another problem with using conventional golf analysis systems in existing facilities is that the space needed between the camera and the individual whose golf swing or other activity being analyzed is too large for existing facilities, requiring the facility to expand the stations at which the activity is practiced, or requiring the removal of some of the facilities to allow the remaining facilities to become larger, but reducing the capacity of the facility.

What is needed is a system and method that can assist a user in analyzing an activity without the expense of an expert such as a coach or other professional trainer, that does not require the user to purchase an analysis system and spend a long time learning how to use it, that can provide simultaneous views of the performance of the activity without moving equipment used to record such performance, can be accommodated in the space for the existing facilities, without the need to set up and remove the entire system each night to avoid vandalism or theft, can integrate with the financial systems of the facility, and can contribute to the revenue of the expert of the facility and/or the facility itself.

The foregoing discussion reflect the current state of the art of which the present inventor is aware. Reference to, and discussion of, this material is intended to aid in discharging Applicant's acknowledged duty of candor in disclosing information that may be relevant to the examination of claims to the present invention. However, it is respectfully submitted that none of the above-indicated references disclose, teach, suggest, show, or otherwise render obvious, either singly or when considered in combination, the invention described and claimed herein.

### DISCLOSURE OF INVENTION

A system and method records an individual performing an activity such as a golf swing and provides a novel kiosk structure with an easy to use intelligent user interface to allow the individual to use the recording to analyze his or her own performance, avoiding the need for, and expense of, an expert and not requiring a long learning curve. The system accommodates input from multiple cameras to allow the playback of different views of the activity without the need to reposition the capture portion of the system in a different location, and can correct or partially correct the images that contain conventional distortion from fish-eye or other lenses that are used to provide close-up images, thereby allowing the use of the system and method in the existing spaces of existing facilities without the need to remove stations. The system may include an array microphone in the kiosk to detect the hit of the target ball while rejecting hits from adjacent stalls, which enables the system to identify and synchronize, at the point of impact, multiple video images of the same swing or of different swings. The system and method employs security features to allow most or all of the equipment used to implement the system and method to remain overnight at the location in which it is installed in the facility to prevent vandalism or theft, without requiring the entire system to be removed and reinstalled each day. The system and method can employ any of a variety of conventional payment systems to allow it to integrate into the operations of the facility in which it will be used. The system and method can advertise and integrate with other facility operations to allow it to direct business to a professional or other operation of the facility.

It is therefore an object of the present invention to provide a new and improved video system for analyzing sports skills such as a golf swing.

It is another object of the present invention to provide a new and improved intelligent user interface to allow the individual to use the recording to analyze his or her own performance.

A further object or feature of the present invention is a new and improved kiosk structure to house the recording, computing, and display components of a video system for analyzing sports skills.

An even further object of the present invention is to provide a novel array microphone in the kiosk to detect the hit of the target ball.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block schematic diagram of a conventional computer system;

FIG. 2 is a block schematic diagram of a system for performing activity analysis according to one embodiment of the present invention;

FIG. 3A is a system for performing and administering activity analysis and ordering goods and/or services according to one embodiment of the present invention;

FIG. 3B is a system for protecting the security of the system of FIG. 2 according to one embodiment of the present invention;

FIG. 4 is a flowchart composed of FIGS. 4A and 4B illustrating a method of performing activity analysis according to one embodiment of the present invention;

FIG. 5 is a flowchart illustrating a method of advertising goods or services, and accepting and transmitting orders for some or all of such goods and/or services according to one embodiment of the present invention;

FIG. 6 is a flowchart illustrating a method of securing and unsecuring an activity analysis system according to one embodiment of the present invention; and

FIG. 7 is a perspective view of a preferred embodiment of the invention, illustrating a video kiosk and remote video camera for use in analyzing a user's golf swing;

FIG. 8 is a perspective view of the video kiosk of FIG. 7; and

FIG. 9 is a plan view of the display and touch panel assembly of the video kiosk of FIG. 7.

### BEST MODE FOR CARRYING OUT THE INVENTION

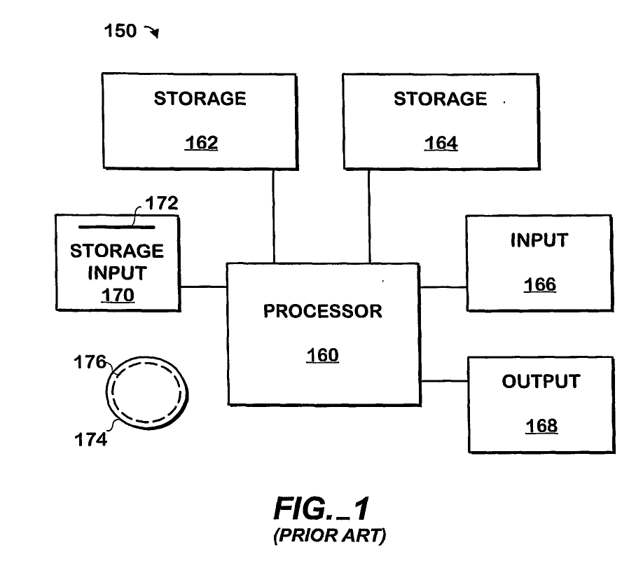

One form of the present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS ULTRA workstation running the SOLARIS operating system commercially available from SUN MICROSYSTEMS, Inc. of Mountain View, Calif., a PENTIUM-compatible personal computer system such as are available from DELL COMPUTER CORPORATION of Round Rock, Tex. running a version of the LINUX operating system or the WINDOWS operating system (such as 95, 98, Me, XP, NT or 2000) commercially available from MICROSOFT Corporation of Redmond Wash. or a Macintosh computer system running the MACOS or OPENSTEP operating system commercially available from APPLE COMPUTER CORPORATION of Cupertino, Calif. and the NETSCAPE browser commercially available from NETSCAPE COMMUNICATIONS CORPORATION of Mountain View, Calif. or INTERNET EXPLORER browser commercially available from MICROSOFT above, although other systems may be used.

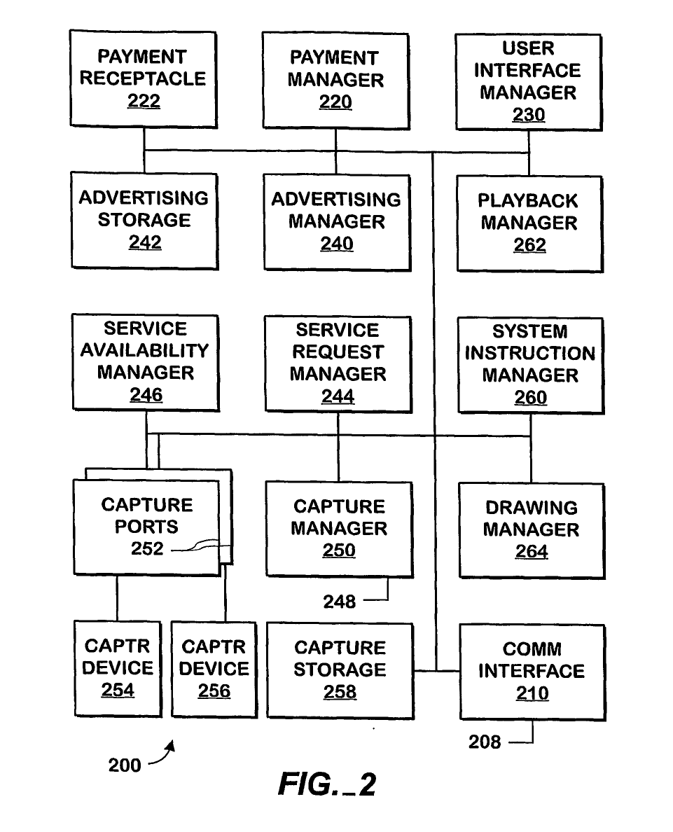

Referring now to FIG. 2, a system 200 for performing activity analysis is shown according to one embodiment of the present invention. The system 200 (and the method described below) may be used to analyze any form of activity, such as a golf swing, a baseball swing, a baseball pitch, throw or catch, a bowling swing or other motion, a football catch, throw or kick, a soccer move, a tennis serve or swing or any other form of activity that can be analyzed.

In one embodiment, all communication into or out of system 200 is made via input/output 208 of communication interface 210. Communication interface 210 may contain a conventional keyboard/monitor/mouse interface, a telephone interface, a printer or other parallel interface, a disk drive, a USB or other serial interface, such as that which may be used to provide data to a removable storage media, or another interface for other conventional forms of input/output. In one embodiment, input/output 208 may be coupled to a network such as the Internet or a local area network or both. In such embodiment, communication interface 210 contains a conventional communication interface that supports TCP/IP or other conventional communication protocols,

Receive Payment.

Payment manager 220 displays via communication interface 210 a welcome screen that explains benefits and features of system 200 and instructs the user how to start the system via making payment via a payment receptacle 222, which may accept cash, tokens, credit cards, smart cards or any other form of payment. The form of payment may be the same token, smart card, or other form of payment that is used by the facility to rent equipment or receive a service. For example, if the activity to be analyzed is a golf swing at a golf course, the form of payment received by payment receptacle 222 may be or include the same form of payment used to obtain a bucket of golf range balls. If the activity to be analyzed is a baseball swing, the form of payment received by payment receptacle may be or include the form of payment used to receive balls in a batting cage. Discounts, such as value of card and time of day discounts, may be offered.

When the user deposits payment via payment receptacle, payment receptacle 222 indicates an amount of payment received and payment manager 220 displays the minimum additional amount needed to operate system 200. When the proper amount has been received, payment manager 220 signals user interface manager 230 to display a user interface to allow the user to operate the remainder of system 200.

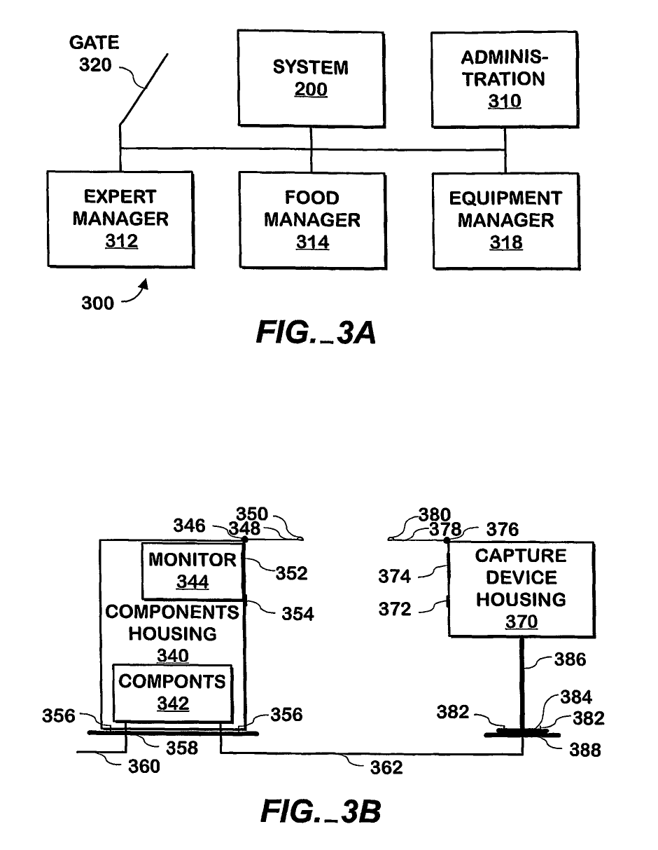

In one embodiment, payment may be accepted by a system administrator, for example, the cashier at a pro shop in a golf course or batting cage. FIG. 3A illustrates system 200 included as part of larger system 300 for performing and administering activity analysis and ordering goods and/or services that contains administration 310. Referring now to FIGS. 2 and 3A, Administration 310 may include a device such as a conventional telephone, a remote control (infrared or radio frequency) or a personal computer or any other form of input and contains a communication interface compatible with communication interface 210. The operator of administration 310 indicates that payment has been received and administration 310 signals user interface manager 230 as described above. In such embodiment, administration 310 may be used in addition to, or in place of, payment manager 220 and payment receptacle 222. The use of administration 310 allows payment to be made using the same mechanism as is used to receive payment for other goods or services. For example, cash can be paid to a cashier, who deposits the cash into a cash register and uses administration 310 to signal user interface manager 230 as described above.

In one embodiment, an electronic gate or other barrier is used to restrict or prevent access to the portion of the facility that is used to record representations of the user performing the activity as described in more detail below. In one embodiment, when signaled as described above, user interface manager 230 sends a signal to the electronic gate (shown in FIG. 3 as gate 320) to release it or otherwise allow access to the portion of the facility that is used to record representations of the user performing the activity as described below.

Record Activity

In one embodiment, user interface manager 230 asks the user if the user would like to work on a particular problem or portion of the activity. For example, if the user would like to improve his or her back swing, or is slicing the golf ball, the user may so indicate to a user interface provided by user interface manager 230 and user interface manager 230 receives and stores an indication of the area in which the user would like to focus.

The user may then indicate to user interface manager 230 that the user wishes for system 200 to begin receiving and storing digital or other representations of the user's performance of the activity. User interface manager 230 signals capture manager 250 to initiate the receipt and storage of digital or other representations of the activity.

In one embodiment, the representations of the user's performance of the activity include visual representations, audio representations, or other types of representations of an activity. Capture devices 254, 256 capture such representations. In one embodiment, each of capture devices 254, 256 include conventional digital cameras and microphones. Although only two capture devices are shown in the Figure, any number of capture devices 254, 256 may be used.

In one embodiment, capture devices 254, 256 are placed or aimed at different locations to allow capture devices 254, 256 to receive different aspects of the activity. For example, a golf swing may be recorded with one capture device 254 facing the user, to capture the image of the entire body of the user and the golf club face from the back swing to the follow through. Another capture device 256 captures a more close up image of the club face at the tee. Another set of capture devices may be positioned to receive similar images from a left handed golfer facing the other direction, and in one embodiment, the user selects which set will be used via user interface manager 230, which provides such information to capture manager 250 to allow capture manager 250 to capture representations of the activity from the proper set of capture devices 254, 256 to the user. User interface manager 230 may also instruct capture manager 250 of any problem or portion of the activity on which the user indicated he or she wished to focus the analysis, and capture manager 250 may select which capture devices 254, 256 will be used based upon any or all of such information.

Capture manager 250 receives the representations of the activity from capture devices 254, 256 and stores them into capture storage 258. Capture storage 258 may be conventional memory or disk storage which stores the representations of the activity. In one embodiment, capture manager 250 adjusts the representations of the activity before or after it stores them into capture storage 258. Such adjustment may be made to reduce distortion that is caused by the close placement of capture devices 254, 256, such as into a conventional-sized driving range station or practice batting cage, for example, using a conventional fish-eye lens, or may be performed by appending the representations from two or more capture devices to form a unified image, such as by combining the images from two or more cameras into a single image. Capture manager 250 adjusts the images to allow the distortion introduced by the fish-eye lens to be corrected so that the resultant image appears as if it were taken from a non-fish-eye lens. Other types of distortion of the representations of the activity may be corrected by capture manager 250. In one embodiment, capture manager 250 first stores the image and then corrects it after it is stored, and stores the corrected image or other representation into capture storage 258.

The user may perform the activity as many times as desired or as instructed by user interface manager 230 and then optionally indicate to user interface manager 230 that he or she has performed the activity. User interface manager 230 then signals system instruction manager 260.

System instruction manager 260 provides instructions to the user regarding how to analyze the representation of the performance of the activity that is stored in capture storage 258. In one embodiment, the instructions are performed step by step. System instruction manager 260 instructs the user to advance or rewind (or such advance or rewind is performed automatically as described below) the representation of the user's performance of the activity to a particular point in time or a set of nearby points in time (each such point in time or set is referred to herein as an “analysis point”) perform one or more steps in the analysis of the activity and indicate when the one or more steps have been completed. System instruction manager 260 then performs similar activities for another analysis point and continues this process until there are no more analysis points (in which case the user can again perform the activity while its representation is captured) or the user runs out of time as described in more detail below.

For example, system instruction manager 260 may instruct the user to use conventional playback buttons to advance from the beginning a playback of the representation of the activity until a certain analysis point is reached, for example, the back swing of a golf swing is at its end. In one embodiment, system instruction manager 260 may illustrate the analysis point by displaying a representation of an expert performer's performance of the same or similar activity frozen in time at a corresponding analysis point (e.g. the end of the back swing). The representation of the expert performer's performance of the activity may be stored in capture storage 258, having been prestored in capture storage 258, by capturing it in the same manner as was used to capture the representation of the user's performance of the activity. This allows the user to identify the analysis point at which he should position the representation of the user's performance of the activity by comparing it with that displayed of the expert performer.

To allow the user to position the representation of the user's activity at the indicated analysis point, in one embodiment, system instruction manager 260 signals playback manager 262. Playback manager 260 displays or plays back (via a monitor coupled to communication interface 210) the representations of the user's performance of the activity stored in capture storage 258 with a user interface to allow the user to advance, reverse, speed up, slow down, or stop the playback of the representation of the activity and responds to user interface commands by displaying the representations of the user's performance of the activity accordingly, as if the user were operating a conventional VCR and the representations of the user's performance of the activity were stored on a tape in the VCR. Playback manager 260 may receive user input via a touchscreen input or the keyboard/monitor/mouse combination, with on screen or on keyboard buttons used to allow the user to perform the playback functions described above. The user uses the buttons to advance, rewind or stop the representation of the user's performance of the activity to display, or otherwise mark, the desired analysis point.

In another embodiment, during or after the capture of the representation of the activity, capture manager 250 marks various points on the representation to allow automatic location of analysis points (or other points near to analysis points) in the representation of the activity, so that either the user need not locate them, or to at least allow the user to find some or all of the analysis points more easily. Such marking may be performed via capture manager 250 using conventional pattern recognition techniques on the representation of the user's performance of the activity, for example, recognizing the end of the back swing by following the pattern of the club head, or by the use of sensors (not shown) coupled to input 248, for example, a sensor tied to the pitching machine to identify when the pitch is thrown, and a timer internal to capture manager 250 to identify when the pitch is estimated to be just in front of, and then over home plate. The inventive hit detector described herein facilitates alignment of different video clips, and synchronization of the start and stop of the video playback. Capture manager 250 marks (either as the capture is occurring or at a later time) such locations and the locations are used by playback manager 262 to locate them in the representation stored in capture storage 258 and display them via a display screen coupled to communication interface 210 as directed by system instruction manager 260. However, playback manager 262 may still allow the user to advance or reverse the playback of the representation of the user's performance of the activity to manually make fine adjustments so that the representation may be stopped at a point in time closer to the analysis point than may be available from the use of sensors, timers or both.

When the user determines that the analysis point requested by system instruction manager 260 has been reached in the playback of the representation of the user's performance of the activity, the user indicates this fact to system instruction manager 260, and system instruction manager 260 provides instructions. These instructions may be to observe the user's performance of the activity (e.g. “Are you standing up straight?”) and report back to a user interface provided by instruction manager 260 or instruction manager 260 may instruct the user to alter the representation of the user's performance of the activity, or both.

The user may be instructed to alter the representation of the user's performance of the activity using any of a variety of methods. For example, if the representation is a digital video representation of the user performing the activity, system instruction manager 260 can instruct the user to alter the representation of the user's performance of the activity by instructing the user to use a graphical drawing tool provided as described below to draw a line from his head to his midsection when the representation of the user's performance of the activity is stopped at the end of the user's backstroke.

In one embodiment, system instruction manager 260 shares the screen with the display and user interface provided by playback manager 262, such as by splitting the screen, or providing one or more insets on the screen. In addition to providing instructions, system instruction manager 260 may provide a sample of a representation of expert performer of the activity, with the result of the instructions having been performed. For example, the representation of expert performer may be stopped at the top of his or her back swing with a line drawn from the expert performer's head to his midsection to indicate what the result of the instructions should look like when the user performs them on the representation of the user performing the activity.

In one embodiment, the user uses drawing manager 264 to draw one or more lines or other shapes or moves one or more lines or other shapes onto the display of the representation of the user performing the activity. Drawing manager 264 provides a graphical user interface and graphical drawing tools that, at least in part, overlay the representation of the user performing the activity being provided to the user from capture storage 258 by playback manager 262 as described above. In one embodiment, drawing manager 264 uses conventional geometric sensing techniques to draw a straight line when the user uses the graphical user interface to draw a line that is approximately straight, or draw a circle or ellipse when the user uses the graphical user interface to draw an approximately circular shape, eliminating the need to require the user to select a particular drawing tool to draw lines or shapes. Thus, lines or shapes can be drawn by simple finger swipes on the touch screen. Erasures may be made by simply swiping or scribbling over the line or shape. The user may be instructed to mark points on the displayed representation of the user's performance of the activity, such as his head and his midsection, and drawing manager 264 draws the appropriate shape in response to the points, such as by drawing a line between the two points.

When the user has completed following the instructions provided by system instruction manager 260, the user so indicates to the user interface provided by drawing manager 254, which verifies that the user has used its user interface to at least perform the functions indicated, one or more indications of which may be provided by system instruction manager 260 to drawing manager 254 to allow drawing manager 254 to make such a determination. For example, system instruction manager 260 may indicate to drawing manager 254 that a line is to be drawn or two points are to be provided, and when the user indicates he has performed the function, drawing manager 254 verifies that a line has been drawn or two points have been provided. Drawing manager 254 may perform additional checks, such as determining whether the line has been drawn that is somewhat vertical, as opposed to a horizontal line that is probably not drawn from the user's head to the user's midsection. Drawing manager 254 receives such indications of the additional checks it should make from instruction manager 260, which system instruction manager 260 provides in conjunction with the instructions it is providing the user, all of which is stored internally by system instruction manager 260.

If the indicated function or functions have not been performed, drawing manager 254 signals instruction manager 260, optionally with an indication of the problem that caused the check to fail, and instruction manager 260 provides appropriate instructions to allow the user to correct the problem and indicate again that the user has followed the instructions using the process described above.

In one embodiment, if the user repeatedly fails to perform the requested check, system instruction manager 260 may signal service request manager 248, which signals any one or more of administration 310 or expert manager 312. Parties monitoring either or both of these devices 310, 312 may then arrive or intervene to help the user. In one embodiment, the screen and sounds displayed to the user are also displayed at administration 310 or expert manager 312 and the users of such devices 310, 312 may establish communications with the user of system 200 via conventional terminal emulation techniques and/or a conventional intercom, allowing the users of the devices 310, 312 to not only describe to the user what to do, but to actually perform the functions requested by system instruction manager 260 from devices 310 or 312 as if they had been performed via the input devices coupled to system 200.

When the user indicates that functions requested by system instruction manager have been performed and/or any checks of those functions pass as described above, system instruction manager 260 may request from drawing manager 264 characteristics about the points, lines or shapes identified as described above and drawing manager 264 replies with the requested characteristics. System instruction manager 264 may identify problems it can detect from the characteristics of the points, lines or shapes identified as described above. For example, if the line between the two points described above is more than a threshold amount out of vertical, system instruction manager 260 may suggest that the user attempt to straighten out his or her stance. If the user is requested to mark points on each of his shoes, system instruction manager 260 may suggest the user spread his or her legs slightly more or less, based on the distance between the points corresponding to the user's shoes indicated by the user, or other similar suggestions, the user's height having been requested and received previously by system instruction manager 260 and used to calculate a range of acceptable distances between the points indicating the locations of the user's shoes.

At the time system instruction manager 260 makes its suggestions, system instruction manager 260 may display representations of an expert performer of that activity performing the functions related to the discussion, which may be provided next to, or otherwise simultaneously with, the representation of the user performing that same portion of the activity, each frozen in time, or being played back roughly synchronized in relation to an identifiable portion of the activity either at full speed or at a slower speed so that the user can compare the representation of a portion of his or her performance of the activity with a representation of an expert performer of the activity performing a similar portion of it. The points, lines or shapes similar to any of those identified as described above may be displayed on the representations of the user and similar points, lines or shapes may be displayed on the representations of the expert performer with instructions, arrows, highlights or the like displayed to facilitate the comparison of the two. For example, a line may be drawn between the two points corresponding to the user's shoes, and then a line of the same size, or proportionate size based on the heights of the user and the expert performer, may be drawn between the expert performer's shoes (and extending beyond them if necessary) to indicate the difference between the user's stance and the expert performer's stance.

To implement such simultaneous display, system instruction manager 260 may indicate to playback manager 262 and drawing manager 264 the portion of the screen in which the representation of the user performing the activity is to be displayed. System instruction manager 260 may identify the points, lines or shapes, respectively, to be displayed either all the time or at certain times, and playback manager 262 and drawing manager 264 display the representation and the points, lines or shapes as requested by system instruction manager 260. System instruction manager 260 may also indicate to drawing manager 264 to display highlighting of certain points, lines or shapes, or to display related points lines or shapes (e.g. a transparent colored band of acceptable movement during a forward swing surrounding the line that was drawn from the user's head to the user's midsection at the top of the back swing as described above).

In one embodiment, the points, lines or shapes that are requested or drawn can correspond to the problem or issue the user identified as the area on which the user would prefer to concentrate as described above, on descriptions of general results of the user's performance of the activity for which system instruction manager 260 may prompt, on descriptions of what has occurred during the user's recorded performance of the activity for which system instruction manager 260 may prompt following the user's performance of the activity (e.g. “In which direction did the ball usually travel after you hit it? A. It went up in the air, but hooked left. B. It went up in the air, but sliced right. C. It went up in the air, generally straight. D. It rolled along the ground.”), the points, lines or shapes previously drawn by the user, patterns detected from multiple responses, patterns it detects automatically from recognition of the representation of the user's performance of the activity, or any of these items. The points, lines or shapes on the expert performer may be predrawn and internally stored for various responses and system instruction manager 260 displays on the representation of the expert performer the appropriate ones from its internally stored set based on any or all of the items described above.

System instruction manager 260 also generates the requests for drawing to the user (or causes to be automatically drawn) and instructs drawing manager 254 to perform the checks described above based on any or all of the items described above. System instruction manager 260 may then unfreeze the representations of the expert performer and the user's performance of the activity for a certain period of time, beginning with, or near the analysis point (or between the analysis point and another analysis point, each marked as described above) to allow the user to compare his performance of the activity with that of the expert performer during the period of time or between the analysis points. For example, in one embodiment, system instruction manager 260 plays or displays the representations of the expert performer that is prestored in capture storage 258 that corresponds to the representation of the user, which is simultaneously being displayed by playback manager 262 and overlays points, lines or shapes on the representation of the expert performer that are related or similar to the points, lines or shapes being overlaid on the representation of the user as described above (and which remain overlaid during such playback). The representations of the expert performer may be stored in capture storage 258 in a manner that allows system instruction manager 260 to locate the portion of the performance of the activity that corresponds to the displayed portion of the user's performance of the activity so that they may be synchronized or closely related.

As noted above, system instruction manager 260 may display representations of the expert performer frozen in time or played back over time at full or slower speed, and may cause playback manager to freeze, or playback the representation of the user at full or slower speed, so that the user and the expert performer are roughly stopped or played back in tandem, or in other combinations. For example, the display of the representation of the expert user may be frozen in time at the same time that a small portion of the representation of the user is played back, either once or repeatedly. System instruction manager 260 may also display instructions, either visually, via prompts on a display screen, e.g. in a pop up dialog box, or verbally, via a conventional sound card and recorded sounds, (e.g. “Notice the position of the expert performer doesn't change very much relative to the line we overlaid. Does your position change relative to the line you drew?”), display a user input to allow the user to answer questions, receive the user input and provide advice in response to the user input received.

System instruction manager 260 then either signals playback manager 262 to change the displayed representation of the user performing the activity to another analysis point, such as when the forward swing of the golf club reaches a position parallel to the ground but before the ball is hit, or signals playback manager 262 to provide the user interface described above to allow the user to advance or rewind the displayed representation of the user performing the activity to the desired analysis point.

The procedure above may be repeated at this analysis point and information from any number of prior analysis points may be incorporated into the advice that system instruction manager 260 provides. For example, system instruction manager 260 may then request the user to perform another function using drawing manager 264 in a manner similar to that described above, or system instruction manager 260 may request the user to note certain characteristics of the representation of the user performing the activity, and optionally indicate to system instruction manager 260 one or more of those characteristics. In one embodiment, some or all of the points, lines or shapes described above may remain or be displayed at various times on the portion of the screen being used to playback the representation of the user performing the activity so that the user can see more clearly any differences in position that occur as the user performs the activity.

For example, system instruction manager 260 may request the user to note whether the position of his or her body has changed relative to the line that was drawn from the user's head to his midsection. The user can compare the position of his or her body to the line to determine whether the user's position has changed.

The user may then optionally identify the changes to system instruction manager 260 via a user interface it provides. For example, system instruction manager 260 may request the user to indicate whether the user is leaning forward, backward or staying in relatively the same position from that of the prior analysis point, by comparing the position of his or her body with the points, line or shape from the prior analysis point that may be displayed on the screen. The user then indicates to system instruction manager 260 the answer to that question and optionally, other questions, via the user interface provided by system instruction manager 260 and system instruction manager 260 stores the response.

System instruction manager 260 may then suggest the user attempt suitable corrective measures by providing tips that have been provided by experts such as golf, tennis or batting professional players or coaches based on the points, lines or shapes, or answers to the questions described above. Again, the representation of the user, with points, lines or shapes identified as described above overlaid on the representation at certain times or all the time may be displayed by system instruction manager 260 simultaneously with (e.g. side by side) an expert performer of the activity with instructions, arrows, highlights and the like to facilitate the user's comparison of his or her performance of the activity with that of the expert performer as described above.

In one embodiment, instead of asking the user to indicate differences, system instruction manager 260 requests the user to perform functions either identical or similar to that described above and signals drawing manager 264, which displays the user interface described above that allows the user to draw on an overlay of the representation of the user performing the activity that is frozen in time as described above. The user uses the user interface provided by drawing manager 264 and drawing manager compares the points, lines or shapes provided previously (which drawing manager stores) to those provided at one or more prior analysis points, identifies differences, and provides the result of such comparisons to system instruction manager 260, which then provides the advice described above. In such embodiment, system instruction manager 260 indicates to drawing manager 264 the prior instance or instances of the points, lines or shapes that should be compared to the current ones and the type of differences that should be returned to system instruction manager 260 by drawing manager 264, and drawing manager 264 complies using conventional pattern matching techniques or other difference identification techniques. System instruction manager 260 uses the differences in place of or in addition to those provided by the user as described above.

The process described above may be repeated any number of times for any number of analysis points. The analysis may be repeated for several repetitions of the activity being analyzed. For example, the process may be repeated for several swings, representations of which have been recorded in a single session.

In one embodiment, the activity is performed under the direction of system instruction manager 260, which instructs the user how to perform the activity. This allows system instruction manager to “drill” the user, either by performing the activity in a certain way (e.g. “Try the full swing, but take your back swing only halfway back”), performing a portion of the activity any number of times (e.g. “Let's just focus on your back swing. Just perform your back swing five times”), or performing a different activity (e.g. “Grab the club and hold it straight out in front of you”). System instruction manager 260 may drill the user in any or all of these ways in response to a problem or area the user identified on which the user would like to focus. Different representations of the user performing these activities may be recorded and displayed in response to the particular activity being performed, such as an overhead video recording of the user's hands or club face. An expert performer may also be shown performing any of these activities as described above.

At any time before, during, or after the analysis procedure described above, system instruction manager 260 may request the user to answer questions only somewhat related, or not related, to the representation of the activity being played back. For example, system instruction manager 260 may request the user to identify whether the trajectory of the golf ball was straight, or curved left or right when the user performed the activity whose representation was recorded, or whether in general he or she has that performance issue. The differences identified as described above and the answers identified by the user allow system instruction manager 260 to tailor the suggested courses of action to the actions and results of the actions performed by the user and other information supplied by the user.

Changing the Camera

At various times during a user session or at all times during a user session, the representations captured by different ones of capture devices 254, 256 may be displayed on the screen and used as described above by playback manager 262 according to instructions received from system instruction manager 260. In one embodiment, the representations are stored by capture manager 250 with indications of time to allow playback manager to identify the time at which various points of the representations were captured. Upon request from system instruction manager 260, playback manager 262 may display more than one representation frozen in time with another representation also frozen at the same time, or played back at related or synchronized times. System instruction manager 260 may instruct playback manager 262 switch from one representation captured by one capture device 254 to another representation captured by a different capture device 256 using the same area of the screen or to display at the same time multiple such representations.

For example, these capabilities allow images from a camera trained on the body of the user and images from a camera showing a close up of the club face at the tee to be shown at the same time, for example, to allow a user to see how his stance affects the club face at the time of impact with a golf ball.

Subsequent Captures

When the end of the representation of the user's performance of the activity has been reached, playback manager 262 signals user interface manager 230, which may instruct the user to record another representation of the user's performance of the activity as described above and repeats the process of recordation of the presentation of the user's performance and analysis as described above, as many times as can occur within the time or number of sessions (consisting of recordation and analysis as described above) for which the user has paid.

After the user has repeated the capture of the user performing the activity at a different time, such as following the instruction provided as described above, system instruction manager 260 may provide additional instruction in the manner described above. However, the user's earlier performance of the activity may be displayed simultaneously with the current performance of the activity in the same manner that the expert performer was displayed as described above to allow the user to determine if the actions he has taken to improve his or her earlier performance of the activity have caused an improvement. In such embodiment, the representations captured earlier can be stored as well as the points, lines or shapes obtained as described above and displayed with the most current representations and the associated points, lines and shapes. Drawing manager 264 may perform a comparison of any number of prior performances of the activity with one or more recent performances using the points, lines or shapes provided as described above and report the result of the comparison to system instruction manager 260, which requests such comparison as described above and uses the results of the comparison (and may direct playback manager 262 and drawing manager 264 to display each such representation and the pertinent points, lines or shapes) to provide further instruction or encouragement (e.g. “Note how you have improved your stance”). In another embodiment, system instruction manager 260 may request, via a user interface it provides, the user to report certain comparisons, either from comparison of prior representations or other characteristics, such as whether the trajectory of the ball is straighter than it was during a prior session. System instruction manager 260 then uses the user's response and optionally the results of any comparison made by drawing manager 264, to provide additional instruction or encouragement.

If the user runs to the end of the time or number of sessions for which the user has paid, user interface manager 260 informs the user to deposit additional payment as described above. In one embodiment, payment manager 220 keeps track of the amount of time or number of sessions remaining and signals user interface manager 260 when the time is, or number of sessions, finished (user interface manager 260 may report the start of each session to payment manager 220 to allow payment manager 220 to keep track of the number of sessions remaining). User interface manager 260 signals instruction manager 260, playback manager 262 and drawing manager 264 to suspend further display, and informs the user to cause an additional deposit to be made as described above and if such deposit is made within a threshold amount of time, such as five minutes, the user's instruction continues where it was when the amount of time or number of sessions for which the user had paid had elapsed and displays were suspended. If the user does not provide such further payment, user interface manager 260 terminates instruction and another user may begin another instruction session as described above.

In one embodiment, when instruction is terminated, system instruction manager 260 provides certain instructions to communication interface 210 for transmission to a printer or other storage device (such as a conventional USB memory token, disk drive, memory card or other removable media), to allow the user to receive hardcopy or other representations of certain instructions related to or identical to the analysis performed as described above. In one embodiment, system instruction manager 260 records identifiers of certain points in time of one or more of the representations of the user performing the activity and provides such identifiers to drawing manager 262, which retrieves the representations at such points in time and sends such representations to system instruction manager 260, which sends them to communication interface 210 for inclusion in the printouts or other storage. System instruction manager 260 may create such printouts or other output at the end of the session if requested by the user via a user interface it provides, or may create such printouts or other output as the analysis provided above is occurring to speed the process of retrieval of the printouts by the user after the user's session is terminated.

Advertising and Requesting Additional Services.

In one embodiment, before, during and/or after the analysis of the activity provided as described above, advertising manager 240 displays on a display screen coupled to communications interface 210 one or more advertisements that have been stored in advertising storage 242. Such advertisements may relate to the services of a professional at the facility containing system 200, equipment purchases from a retailer located at or near the facility, food or beverage service available at or near the facility or other products or services. Associated with the display of some or all of the advertisements, advertising manager 240 may display a user interface that allows the user to order such goods or services or related goods or services. Information stored in advertising storage 242 associated with the advertisement may indicate whether such goods or services may be ordered and if so, information that can be used to receive the order from the user and the manner in which the order for goods or services is to be transmitted from system 200 to an entity that can fulfill the order.

The information stored in advertising storage 242 may include advertisements that are displayed at more than one facility, and are supplied to advertising storage by a party other than the operator of the facility at which system 200 is operated, as well as advertisements targeted to that facility and displayed on a system 200 or multiple systems 200 that are operated on that facility. In one embodiment, a third party customizes or creates such facility specific advertisements, and that third party may be the third party that also supplies advertisements that will be displayed at other facilities as described above. The facility-specific advertisements may be customized or created by an employee of the facility using a user interface provided by advertising manager 240. Advertisements supplied by a third party may be provided to advertising storage 242 of systems on that facility via an Internet or other connection provided by communication interface 210 or via a disk that is loaded onto a disk drive that is part of communication interface 210.

If the user indicates that such goods or services are to be ordered, advertising manager 240 may request from the user additional information according to the information stored associated with the advertisement in advertising storage 242 and then provides the information received from the user with any optional information and manner of ordering information associated with the advertisement to service request manager 244.

Service request manager 244 provides the order to an entity outside of system 200 using the manner indicated by the manner of ordering information associated with the advertisement. For example, the manner of ordering for an advertisement for the snack bar at a golf shop may indicate that the order is to be provided to food manager 314 with an indication of how much time is left on the user's account with system 200. The amount of time may be maintained by payment manager 220 as described above and retrieved by service request manager 244. Food manager 314 then provides some or all of the order information to a cook or other food service personnel, with the amount of time remaining to allow the cook or other personnel to time the order with the end of the user's instruction session on system 200.

An advertisement for an instruction session from a live professional may be made and if the user indicates that such an instruction is desired, advertising manager 240 may provide any order information and manner information to service request manager 244, which provides an order to expert manager 312, which notifies the expert that such a session is desired. Expert manager 312 may contain a personal computer or a telephone held by the expert, and the manner of making the order may be ringing the telephone via a telephone number specified and playing a message to the expert indicating the station identifier of system 200 and the fact that an instruction session is desired.

In one embodiment, each advertisement may be provided in a sequential order stored in advertising storage 242 or according to a schedule or an event corresponding to the analysis. For example, after certain issues (e.g. too much body movement) have been identified and/or noted and discussed by system instruction manager 260 as described above, system instruction manager 260 may signal advertising manager 240 with a code for this event (and optional text to insert in the advertisement), and in response, advertising manager 242 may scan advertising storage 242 for an advertisement for the services of a professional coach and display the advertisement, with the text received from system instruction manager 260 optionally inserted. The advertisement may state that the golf shop professional is on site and can be called for an instant lesson.

Other events may include the amount of time remaining in the session, so for example, an advertisement for the snack bar may be displayed after the session terminates or a short time before, so that the user can place an order or be reminded that food from the snack bar is available. Payment manager 220 may provide to advertising manager 240 indications that the session will end in two minutes, and another when the session has ended, so that advertising manager 240 may scan advertising storage 242 and display advertisements that have been marked in advertising storage 242 as advertisements to display following notification of such event.

In one embodiment, the advertisements and/or the ability to place orders corresponding to such advertisements are under the control of service availability manager 246. If a service (or a product) is unavailable, service availability manager 246 either inhibits the display of an advertisement for the service, inhibits the placing of an order for the service, or both. Service availability manager 246 may identify that a service is either available or unavailable by comparing a schedule for each service to a system clock (not shown) or by receiving notification of the available or unavailable status by means of administration 310, expert manager 312, food manager 314 or equipment manager 318, or by other means, such as a telephone call received with a DTMF service identifier decoded by communication interface 210 and provided to service availability manager 246. Service availability manager 246 uses any or all of such means of identifying the available or unavailable status of a good or service and provides a code for that good or service to advertising manager 240, service request manager 244 or both, when each such component 240, 244 requests the status prior to displaying the advertisement or providing a user interface to accept an order. Each advertisement for a good or service contains a code that relates to the type of good or service the advertisement contains. Before displaying an advertisement or the user interface to allow an order to be placed, advertising manager 240, service request manager 244 or both send the code to service availability manager 246 and receive its status and allow the ad to be displayed or the good or service to be ordered or both based on the status received.

In one embodiment, an advertisement may contain two messages. One message is played by advertising manager 240 if the good or service is available and that good or service may be ordered as described above and another message is played by advertising manager if the good or service is not currently available (e.g. “Our snack bar is currently closed, but we're open from 7 to 5”), and ordering of that good or service is disallowed.

In one embodiment, system instruction manager 260 includes in the printout it provides as described above, coupons and/or advertisements and/or game pieces for goods or services that it requests and retrieves from advertising manager 240. Credit slips towards a frequent user program may be issued that may be scanned by a scanner coupled to communication interface 210 to allow payment manager 220 to determine whether sufficient credits have been received. Alternatively, payment manager 220 may maintain such credits for each user each time the user pays for use of system 200 as described above, such credits associated with a user number or credit card number entered to payment manager before or after payment is received, and payment manager 220 informs the user that use of system 200 is discounted or free when sufficient credits have been maintained. The credits from payment managers 220 in multiple systems 200 throughout a facility or in multiple facilities may be cumulated by the payment manager 220 with which the user is in communication (e.g. that payment manager 220 requests the credits for that user from all other payment managers 220 with which it is in communication via a network and if the credits are sufficient, instructs the other payment managers 220 to reduce or eliminate the credits for that user and does the same for its own internal store of credits for that user when the user is provided discounted or free use.)

When so requested, advertising manager 240 scans advertising storage 242 for any or all of game pieces, coupons or advertisements, that may be stored with, or in addition to, or both with and in addition to, the advertisements stored therein. Advertising manager 240 provides the coupons, advertisements game pieces or credit slips, to system instruction manager 260, which includes them in the printout or printouts it provides.

In one embodiment, system instruction manager 260 also provides to the media representations of the expert user, which may or may not include the markings as described above, and may include software that operates similar to any or all of some or all of system instruction manager 260, some or all of playback manager 262, and some or all of drawing manager 264 to allow the user to, using a personal computer system away from the facility in which system 200 is employed, view his or her, and the expert performer's, performance of the activity, and receive instruction and draw on the user's representation of the performance of the activity as described above. In one embodiment, the media may be coupled to a device that allows such operation in conjunction with a conventional television set to allow the user to perform the analysis described above without the use of a computer system.

In one embodiment, system instruction manager 260 also adds to the media statistics regarding the user's performance of the activity. Upon subsequent use of system 200, system instruction manager 260 reads such statistics from the media (or allows entry of such statistics by the user) to facilitate a comparison with prior uses of the system, so that the user can identify if one or more problems identified in a prior use have gone away or improved. In one embodiment, the statistics are internally stored by system instruction manager 260 associated with the identifier of the user described above and may be retrieved from storage of that system instruction manager 260 or other system instruction managers 260 of other systems 200 to facilitate such comparisons. Optionally, an advertising audit or exposure measurement mechanism can be included. This will enable the administrator to monitor frequency, time on screen, and other parameters for any advertisement, and provide a means for billing advertisers.

User Can Request to Focus on One or More Issues

In one embodiment, when the user starts the session, user interface manager 230 provides a user interface that allows the user to specify one or more issues on which the user would like to focus. The user may indicate he or she would like the analysis to focus on one or more of the issues, and if so indicated, user interface manager 230 provides to system instruction manager 260, and optionally, to advertising manager 240 an indication of the issues indicated. System instruction manager 260 may tailor the analysis described above according to the issues indicated. Advertising manager 240 may tailor the advertisements or coupons it provides as described above according to the issues indicated.

Housings and Electrical Supply

To protect the security of system 200, it may be placed into one or more security housings, such as those schematically illustrated in FIG. 3B. FIG. 3B is a system for protecting the security of the system 200 of FIG. 2 according to one embodiment of the present invention. Referring now to FIGS. 2, 3A and 3B, capture devices 254, 256 may each be placed in the same, or different one of capture device housing 370 and some or all of the remaining components 342 of system 200 may be placed in components housing 340, each of which will now be described.

Components housing 340 may be made from a plastic, wood or metal housing such as a weather-resistant box suitable for containing components 342 and a conventional display 344 or display, keyboard and mouse. If the monitor 344 is used without a user-accessible keyboard and mouse, monitor 344 may be a conventional touch screen monitor that can accept input as well as display output. Monitor 344 is coupled to components 342 via a connection (not shown), and components 342 may be embodied as computer hardware and software in a conventional personal computer system as described above.

Components housing 340 may be mounted on a conventional cement pad 358 with bolts 356. Cement pad 358 may be placed on or in the ground. Conduit 360 opens to components housing 340 and leads to a conventional pro shop or other part of the facility from which power and/or networking and/or telephone signals are available. In one embodiment, conduit 360 is made from several conduits run to obtain such services from different locations. Conduit 360 may be buried in the ground or run overhead.

Conduit 356 runs between capture device housing 370 and components housing 340 to receive signals from capture devices 254, 256 and provide them to capture ports 252. In one embodiment, such signals are received wirelessly, and therefore conduit 356 may carry only power, and it may not run to components housing 340, but may run to another location containing a source of power, or it may not be used at all. In another embodiment, conduit 360 and/or conduit 356 is not used: all communication is wireless and power is received from batteries charged via a solar panel (not shown).

Monitor 344 is viewable or accessible via screen lens 352, which may be integral to monitor 344 or may be in addition to any screen integral to monitor 344 and may be made from conventional PLEXIGLASS, LEXAN or other impact resistant materials. Screen lens 352 may be optionally covered by door 348 mounted on hinge 346, which, when folded in the downward position covers screen lens 352 and can be locked in the downward position via locking mechanisms 350, 354, which may be a conventional hasp and padlock or other locking arrangement. When locked in the downward (i.e. closed) position, monitor 352 is inaccessible to a user, and thus, door 348 may be closed to provide additional security and protection from weather when the system 200 is not expected to be used, such as when the facility in which system 200 is employed is closed.

Door 348 may be placed or locked in the open position shown via a locking mechanism internal to hinge 346 or via a support post (not shown) hinged from door 348 and supported by components housing 340 to provide a canopy to prevent glare on screen lens 352 or may be opened further and supported by the top of components housing 340 when in the opened position.

In one embodiment, a drawer (not shown) pulls out from the side of component housing 340 to which screen lens 352 is attached to hold one or more conventional input devices such as a keyboard and mouse, with high security features such as cable housings to prevent damage, covers to prevent spilled liquids and locks or other hardware mounted to the drawer to prevent theft. The drawer may be covered by door 348 when in the closed position to prevent theft or vandalism of the input devices and provide further protection from the elements. Capture device housing 370 may be attached to stand 386 mounted on base 384 bolted using conventional bolts 382 to cement pad 388 mounted into or on the ground. Capture device housing 370 can also be mounted directly onto cement pad 388.

Capture device 254, 256 may capture the representations described above via port 374 which may contain a lens made of materials such as a PLEXIGLAS or LEXAN or other high security materials or a screen. Although only one port 374 is shown, multiple ports 374 may be provided in different locations on capture device housing 370, with one or more capture devices 254, 256 per port 374. Door 378 may be mounted on hinge 376, which may lock door 378 in the open position shown in the figure to avoid glare (and anti glare coatings may be applied to port 374 and/or monitor lens 352), or door may be opened further and rested on top of capture device housing 370. Door 378 may be locked in the closed position via hasp 380, 372 and padlock or other lockable hardware to protect capture devices 254, 256 from theft, vandalism or weather.

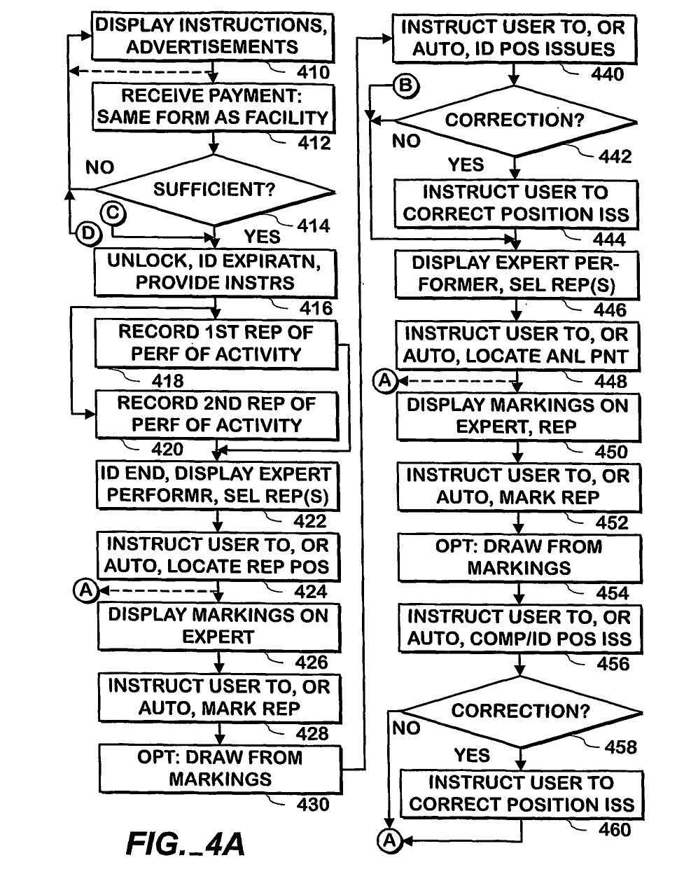

Referring now to FIG. 4, which is composed of FIGS. 4A and 4B, a method of analyzing an activity is shown according to one embodiment of the present invention. Instructions for operating the method, such as instruction for making payment, may be displayed 410 either continuously (as indicated by the dashed line in the Figure) or upon the occurrence of an event, such as a start button being pressed or an indication that payment has been received (in which case step 410 may follow step 412). Payment is received 412, which may be in the same form as payment for other goods or services may be made at the facility in which the method of FIG. 4 is performed. Step 412 may include receipt of the identification of the user and payment may be received by deducting credits held on account of the user as described above. If payment is not sufficient 414, additional instructions may be provided 410 until payment is sufficient 414, after which the method continues at step 416.

Step 416 may include the unlocking of an electronic gate or providing another signal that allows the use of the portion of the facility used to record representations of the user performing the activity as described herein. An expiration time or other expiration event (e.g. number of sessions) is identified and instructions are provided 416, for example, informing the user of the method to press a start button, begin performing the activity to be analyzed one or more times and then press an “activity completed” button. Step 416 may include the accumulation of credits towards discounted or free play as described above. Step 416 may include the display and receipt of activation of the start button. As noted above, the instruction may be an instruction to perform the activity normally performed by the user, or portions of that activity or a different activity, such as a drill, may make up the activity being analyzed, which may change at each iteration of step 416.

In one embodiment, step 416 includes the presentation of a user interface and receipt of a selection of a particular aspect of the activity on which the user wishes to work, to allow the focus to remain on one or more such particular problems the user is known to have or areas in which the user would like to improve. Any or all of the remainder of the steps in the method of FIG. 4 may be performed in response to the user's selection of one or more such problems. As described above, any or all instructions or other information provided in FIG. 4 may be provided verbally or visually. The method continues at step 418 and 420.

At steps 418 and 420, different representations of the user's performance of the activity are recorded. The different representations may be different forms of representations or the same form (e.g. video) recorded from different angles, and the different representations may be recorded at the same time or at different times. Although only two different representations are recorded in the Figure, any number of representations may be recorded in the same manner as steps 418 and 420. Steps 418 and 420 may include marking one or more of the representations at one or more reference points in time as described above. Step 416 may include the display of a user interface requesting the identification of the dominant hand of the user and step 416 may include determining which representations of more than that many representations will be recorded, and steps 416 and 418 are responsive to such determination. Steps 416 and 418 may include adjusting the representations for distortion, such as from a fish-eye lens, appending representations together or other adjustments, or such adjustments may be performed at a time after the representations have been recorded.

The end of the user's performance of the activity may be identified (e.g. if the user presses the “activity completed” button), or the end of the activity may be identified and provided to the user, for example, by notifying the user that the time for recording representations of the user performing the activity have ended.

A representation of an expert performer stopped at a first analysis point may be displayed and one or more of the representations recorded in step 418 or 420 is selected based on the portion of the activity being analyzed 422. The user may be instructed to move the representation of the user performing the activity to an analysis point such as that corresponding to that at which the expert user is displayed, for example, starting from the beginning of the recorded representation of the user's performance of the activity 424. Step 424 may include displaying a user interface, receiving commands from the user via that interface, and altering the display of the representation of the user's performance of the activity according to the commands received. In another embodiment, the analysis point may be identified from the recorded representation and the representation is automatically displayed at that analysis point as part of step 424.

Markings of one or more points, lines or shapes may be optionally displayed 426 on the representation of the expert performer of the activity and the user may be instructed 428 to mark the one or more displayed representation of the user's performance of the activity, such as in the same manner as the expert performer has been marked, and such markings may be received. In another embodiment, the markings are automatically provided on the representation of the user's performance of the activity as described above. One or more lines points or shapes may be derived and displayed 430 based on one or more of the one or more representations of the user's performance of the activity from the markings identified in step 428 and the method continues at step 440.

At step 440, the user is instructed to identify position or other issues, such as by making a comparison of the lines points or shapes drawn or identified in steps 428 or 430 or such comparison is automatically performed as described above. The user may indicate the result of the comparison as part of step 440, and if a position or other correction of the user's performance of the activity is warranted 442 by the results of the comparison in step 440, the user is provided with instructions regarding the correction, and may be shown the expert performer performing and/or correcting the position issue 444.

The expert performer may be shown performing the activity until another analysis point is reached in the representation of the expert performer's recorded performance of the activity, and one or more of the representations of the user performing the activity are selected and displayed 446.

The user is instructed to advance the displayed one or more representations of the user's performance of the activity to a different analysis point, such as that which may correspond to the representation of the expert performer, displayed as described above, or such analysis point is automatically identified and the one or more representations displayed in step 446 are advanced or rewound to approximately the analysis point. Markings may be displayed 450 on the representation of the expert performer 448 and the user is instructed to mark, using any number of points, lines or shapes, one or more of the representations of the user's performance of the activity, and such markings are received as described above, adjusted as described above (e.g. to straighten lines or make circles or ellipses or other shapes based on what the user has drawn, the expected line or shape, or both), or such markings are automatically identified 450 and additional markings may optionally be identified and displayed 452 using the markings received in step 450 as described above. In another embodiment, the markings from any or all of steps 426-430 or other prior analysis points remain or are displayed at various times on the screen as steps 440-446 are performed and in such embodiment, steps 450-454 may or may not be performed.

In one embodiment, at step 424 or 448, or at other steps, it may be detected that the end of the recorded representation of the user's performance of the activity has been reached, in which case, as indicated by the dashed lines in the figure, the method continues at step 470 as described below.

The user may be instructed to make a comparison 456, for example, between his position and the markings remaining displayed from either or both of steps 428-430 or between the markings from steps 428-430 (which may be displayed as part of step 456) and those from steps 452-454 or any number of other prior analysis points, or between the markings on the representation of the expert performer's performance of the activity and those on the representation of the user's performance of the activity, or any other comparison and the user is instructed to report the result of such comparison. Step 456 may include automatically identifying the result of such comparison without user input as described above.

If a position or other correction of the user's performance of the activity is warranted 458, the user is instructed 460 to make the correction as described above and the method continues at step 470 and otherwise 458, the method continues at step 470, although in other embodiments, the user may be instructed what he or she is doing right at step 460A (not shown) between the “No” branch of step 458 and step 470 even if no correction is warranted.

At step 470 of FIG. 4B, the current time is compared with the expiration time identified in step 418 (or an event counter, such as how many analysis points or sessions have been analyzed as described above is compared against a threshold) and if the comparison indicates the analysis has ended 472, the user may be informed that the end of the paid activity analysis has been reached and instructed to add more payment 474 to receive additional activity analysis or indicate that he wishes to terminate the analysis (for example, by pressing a button or not adding additional payment). If the user adds additional payment 476, the method continues at step 478 and otherwise 476, the method continues at step 480. If at step 472, the comparison of step 470 indicates that the analysis has not ended, the method continues at step 478.

At step 478, if there are additional analysis points in the stored representation of the user's performance of the activity, the method continues at step 446 and otherwise the method continues at step 416 (although the identification of the expiration time or other determination of the end of the analysis need not be performed here).

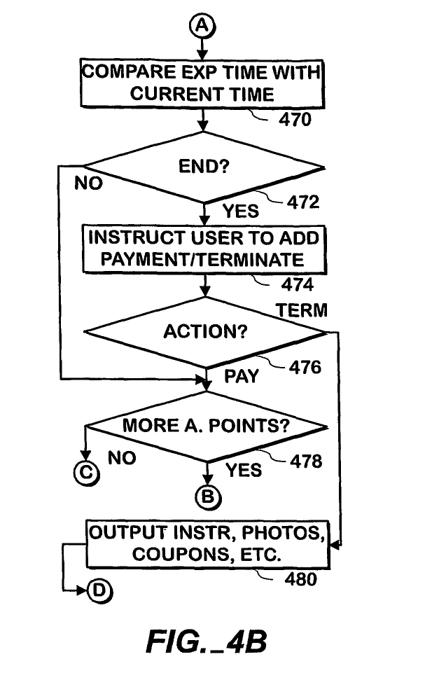

At step 480, the user may receive via a printout or other removable media that summarizes or contains the instructions and suggestions made for improvement, as well as game pieces, credits for free or discounted future use, or advertisements or coupons for subsequent operation of the method of FIG. 4 or other related goods and services, such as those that are advertised and/or can be ordered as described in FIG. 5. As described above, the media may have been output during other steps of FIG. 4 so that the user does not have to wait so long for the output to become available as if the printouts or other output had started at step 480. The output may include still images from any of the representations of the user's performance of the activity and/or the expert performer's, and may or may not include the points, lines or shapes described above. In one embodiment, step 480 may include portions or all of representations of the user's performance of the activity, and may include software for operation as described above. Following step 480, the method then continues at step 410.

FIG. 5 is a flowchart illustrating a method of advertising goods or services, and accepting and transmitting orders for some or all of such goods and/or services according to one embodiment of the present invention. The steps of FIG. 5 may be performed as part of step 410 of FIG. 4, but also as part of any or all of the other steps of FIG. 4. Referring now to FIG. 5, the availability status of one or more goods and/or services may be received 510 as described above. The receipt of the availability status in step 510 may be made as part of an independently operating sub-process of the method of FIG. 5. An advertisement and ancillary information is retrieved 512 as described above. As described above, advertisements may be received from parties other than those operating the facility at which the method is performed, and may include advertisements for products and/or services that are also displayed at other facilities or advertisements displayed only at the facility at which the method is performed that are either received from third parties or developed by employees or contractors of the facility using an advertising tool or another capability. Advertisements may be received via a network, such as the Internet or via media such as a CD-ROM or DVD.

The retrieval of step 512 may include retrieval in a certain order, either immediately or after a prior advertisement has been displayed for a threshold period of time without an order being placed or after an order is received, or in response to an event or time related to the method of FIG. 4 as described above. The advertisement may include an advertisement for a good or service related to the activity being analyzed in FIG. 4.

The availability status of the good or service corresponding to the advertisement is identified 514, for example, if the display of the advertisement requires such information. If the availability status identified in step 514 indicates that the good or service corresponding to the advertisement retrieved is available 520, the method continues at step 530, described below, and otherwise 520, the method continues at step 522.

If the ancillary information indicates that the advertisement is to be omitted if the good or service corresponding to the advertisement is not available 522, the method continues at step 512 and otherwise 522, if the ancillary information for the advertisement indicates that an alternate advertisement is to be displayed if the good or service corresponding to the advertisement retrieved is not available 524, the alternate advertisement (part of the ancillary information) is displayed 526 and the method continues at step 512. Otherwise, the regular advertisement retrieved is displayed 528 and the method continues at step 512.

If the availability status for the good or service corresponding to the advertisement indicates the good or service is available 520, the regular advertisement is displayed and a user interface allowing an order is optionally displayed in accordance with the ancillary information retrieved with the advertisement 530. If a user uses the user interface to initiate an order within a set amount of time and the user completes the order 532, the order is transmitted 534 using a method described by the ancillary information, such as by computer network (wired or wireless), telephone or otherwise. The method continues at step 512.

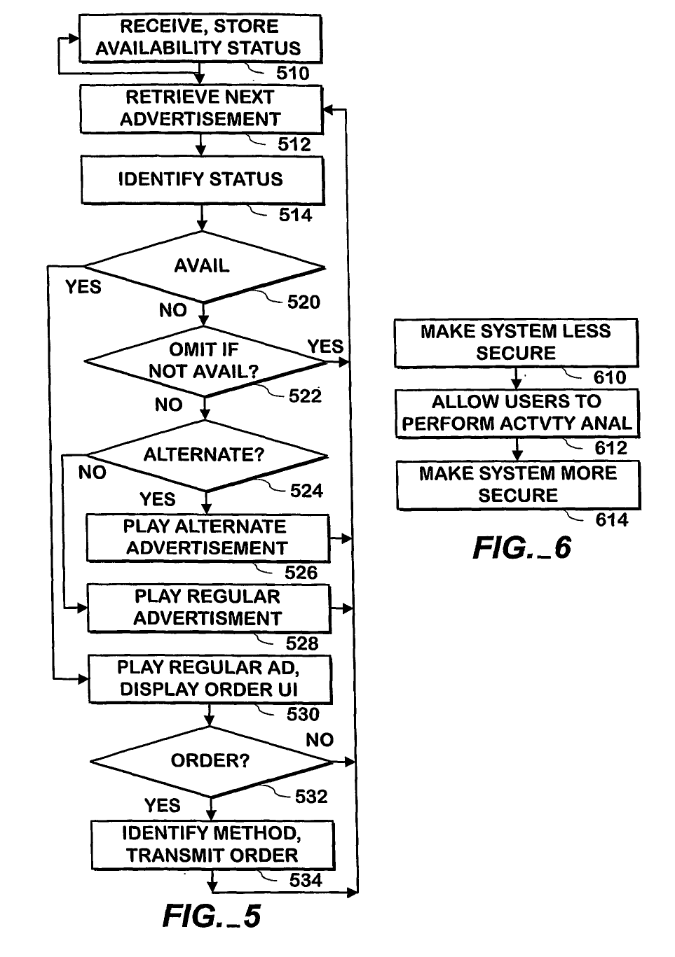

Referring now to FIG. 6, a method of unsecuring and securing an activity analysis system is shown according to one embodiment of the present invention. An activity analysis system is made less secure 610, for example, upon the opening of business of a facility in which the system is to be used. Users are allowed to use the system 612 to perform activity analysis and optionally receive advertisements and place orders as described above and the system is made more secure 614 without moving it to a more secure location, for example, at the close of business of the facility in which the system is used.

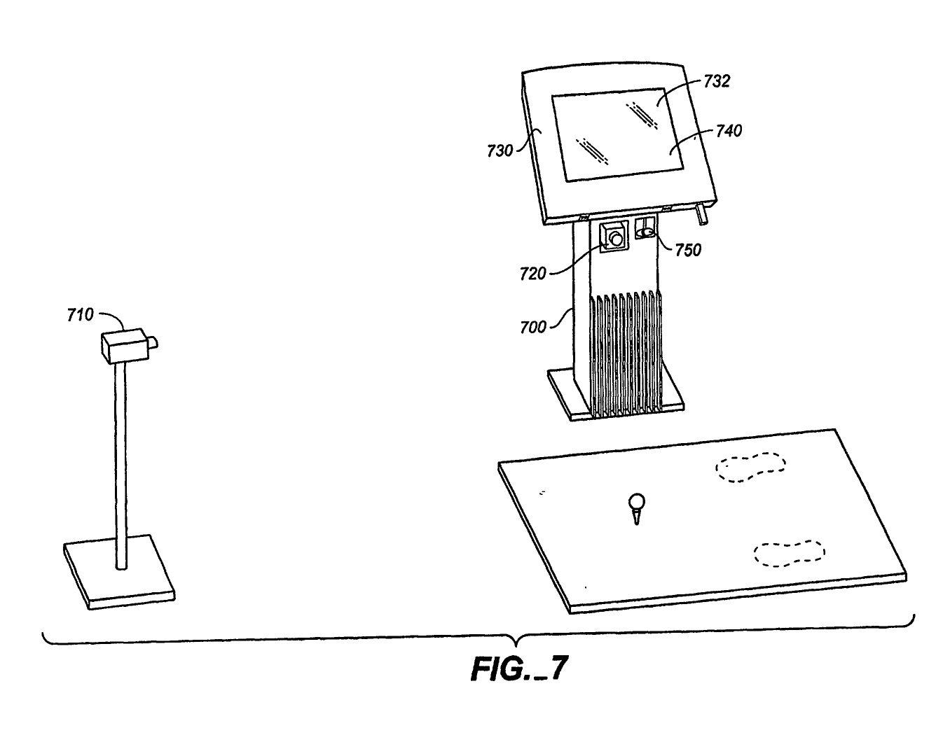

FIG. 7 is a perspective view of a preferred embodiment of the invention, illustrating a video kiosk 700 and remote video camera 710 for use in analyzing a user's golf swing. In this embodiment, the inventive apparatus includes a video kiosk 700 suitable for installation in driving ranges and batting cages. Kiosk 700 contains a powerful computer (not visible in this view) with a high speed camera 720, and a display head 730 with a high brightness flat panel display 732 and touch panel interface 740. A second capture device in the form of a remote camera 710 is placed facing the golfer while the kiosk 700 is positioned behind the target line. Alternatively, camera 720 could be located separate and remote from the kiosk to allow more flexibility in the placement of the kiosk. Since the system is intended for unattended operation, card reader 750 allows use of Smart Cards or magnetic strip cards for payment.

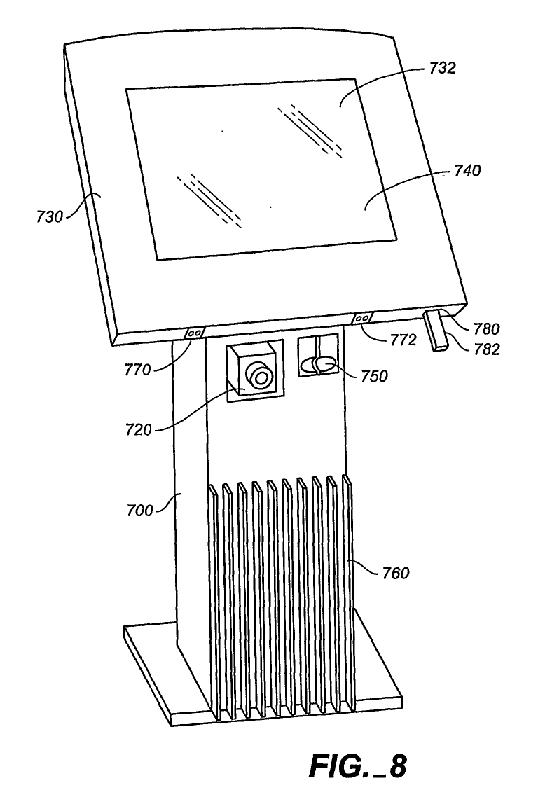

FIG. 8 is a perspective view of the video kiosk 700 of FIG. 7. The kiosk 700 contains a high-brightness active-matrix LCD display 732 and touch panel assembly 740 that must be able to operate in direct sunlight. The high solar flux through the glass touch panel 740 and the relatively high power dissipation of the bright backlight required for sunlight readability may cause elevated operating temperatures of the LCD module. These high temperatures may cause the LCD display to become temporarily unusable due to display darkening, interfering with the usability of the kiosk. Additionally, long-term display operation at high temperatures may lead to degraded performance or early failure of the display. The high temperature conditions in the display may exist even when a special outdoor touch panel is used that incorporates a film layer intended to reflect much of the incident solar infrared radiation.

In order to lower the display operating temperature, an air blower may be mounted in the lower section of the kiosk and ducted into the display assembly by flexible ducting. The display assembly enclosure may be engineered such that air flows both between the touch panel 740 and the LCD 732 front face, and across the rear of the metal backlight reflector. This forced-air cooling from both sides of the display assembly may remove a substantial portion of the heat load from both the solar and backlight sources and thus reduce the operating temperature of the LCD.

The front of the kiosk base may contain a section of finned aluminum extrusion 760 that is essentially the width of the unit. This finned extrusion 760 composes a substantial portion of the base and serves several purposes. It is the primary means for removing heat from the heat-generating components in the sealed kiosk interior and for coupling this heat to the exterior environment. Air that has been warmed by passage through the display assembly may be circulated within the interior air volume of the kiosk and the heat may be exchanged to the external environment via this large finned extrusion in the kiosk base. The extrusion is also a structural component of the kiosk frame, and the external vertical fins of the extrusion are a decorative element in the aesthetic design of the kiosk.

The opposite side of the extrusion is a flat metal surface that is directly exposed to the kiosk interior. In order to accomplish efficient thermal coupling to this surface, the computer motherboard and other PCB assemblies containing heat-generating components may be mounted with their component sides facing towards the extrusion. Heat from major heat generating components on the PCBs (e.g. the computer processor) is conductively coupled to the extrusion by means of one or more metal coupling blocks or plates, with appropriate thermal interface materials sandwiched between the metal surfaces in the thermal path. This conductive path has very low thermal resistance and therefore achieves a minimal temperature difference between the heat-generating components and the external surface of the extrusion.

The large exterior surface area of the finned extrusion 760 allows it to effectively transfer heat to the exterior air via natural convection. Additionally, the large thermal mass of the extrusion helps to lower the operating temperature excursions of the components since the extrusion temperature reflects a long-term average of system power dissipation rather than the short-term peak power dissipation of each individual component.

To allow operation in extreme environments, the kiosk may include a fan panel and fan shroud at the bottom of the kiosk to provide additional airflow over the extrusion. The kiosk interior remains sealed even when these fans are used, so this approach is superior to conventional forced-air cooling approaches that allow external air to directly contact (and contaminate) interior components.

The kiosk may include an array microphone mechanism utilizing two microphones 770, 772 mounted near the left and right sides of the kiosk display head 730. Each microphone is mounted in a vibration isolation block in order to reduce the pickup of unwanted noise from other system components. The acoustic openings of the microphones are preferably located on the underside of the display head 730 for maximum protection from weather and vandalism. Alternatively, the microphones could be located at any other point on or near the kiosk.

Because the microphones 770, 772 are located some distance apart, sounds from a ball impact will arrive at the two microphones at different times unless the sound travels the same distance to each microphone. Since the axis of the microphone array is parallel to the face of the kiosk, the arrival time of an impact sound at each microphone will depend on the angular position of the sound source relative to a line normal to the face of the kiosk. For example, a ball that is hit when centered in front of the kiosk will produce signals in both microphones simultaneously. However, a ball that is hit when “off axis” (not centered in front of the kiosk) will produce an acoustic signal that arrives at one microphone before it arrives at the other. By digitizing the signals from both microphones simultaneously and processing the resulting samples with a digital algorithm, it is possible to determine the sound arrival time difference between the two microphones. From this time difference and knowledge of the approximate distance to the ball, the appropriate mathematics can determine the approximate angular direction of the sound source.

By setting an acceptance window of sound arrival angles (i.e. arrival time differences) within the hit detection algorithm, it is possible to filter out ball impacts in adjacent driving range stalls even when they are much louder than the desired trigger event of ball impact in the system stall. Additionally, sounds that do not fit the characteristic profile of ball hits are filtered out by the preprocessing code even if they arrive simultaneously at both microphones. The combination of the preprocessing filtering and the angle determination for impacts result in a reliable hit detection mechanism with reduced sensitivity to false triggering by speech, aircraft, gardening equipment, etc. As discussed supra, the hit detector facilitates alignment of different video clips, and synchronization of the start and stop of the video playback.

Although it is usual practice for the kiosk to be installed with the front face normal to the desired acoustic trigger event (i.e located directly behind the target line), this is not necessary for the proper operation of the hit detection mechanism. The hit detection algorithm may be adjusted via setup parameters to allow acceptance of trigger events from a desired range of incidence angles, while rejecting events originating from outside this angular range. Thus the kiosk may be mounted in a position that is rotated from the target line if this is desirable in a specific installation.

The illustrated array microphone implementation uses two microphones 770, 772, but the array microphone approach is not limited to only two microphones or to using microphones located within the kiosk enclosure. Additional microphones and software processing can be added either inside or outside the kiosk to allow enhanced accuracy in locating desired acoustic triggering events and in rejecting interfering sounds.

Display head 730 may also include a port 780 for insertion of a flash memory stick 782 of other portable memory device, as described supra. Alternatively, the port 780 may be located on any other portion of the apparatus, such as the kiosk base.

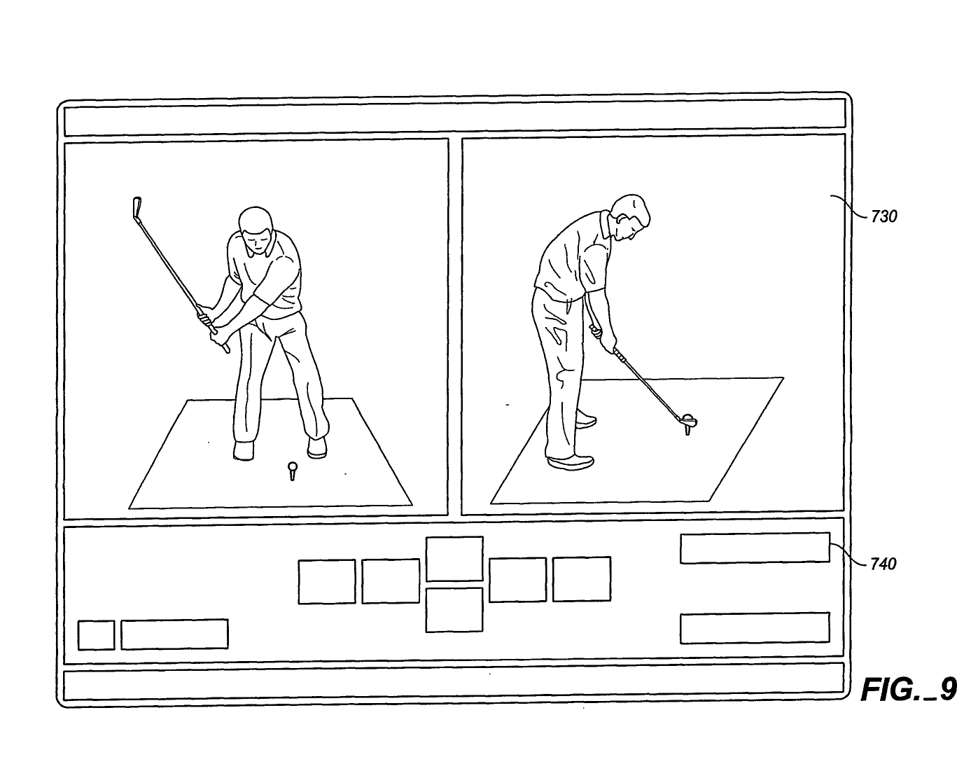

FIG. 9 is a plan view of the display 730 and touch panel assembly 740 of the video kiosk of FIG. 7. The interface is designed to be as easy to use as an ATM machine or a gas pump. Touch panel buttons to play, slow, pause, or step frame by frame forward or backward are simple to master.

The video capture system is preferably optimized for capturing high-speed swings. Unlike general-purpose video camcorders that often blur fast motion, the video capture system records clear frame-by-frame views of even the fastest portions of the swing. This allows detailed analysis of club and body positions at each point in the swing, and provides the maximum feedback to the user about whether they are maintaining the desired athletic form. Specialized digital cameras may be used for the image capture, and proprietary software adjusts the cameras for optimal image quality over a wide range of lighting conditions.

The inventive system may capture two synchronized views of each swing from the vantage points of the two different cameras. These two views stay synchronized as the user plays the video stream or steps through different portions of it. The two perspectives provide a powerful aid to understanding the motion and identifying faults in the user's form.

Features of the preferred embodiment of the inventive apparatus may include, but are not limited to, the following:

1. Fixed installation available for everyday use without operator set up.

2. Sealed, gasketed system with sufficient ruggedness to survive a wide range of environmental conditions.

3. Demonstration mode to illustrate the use of the system at no charge.

4. Payment mechanism to allow the user to approach the system and insert a Smart Card to activate it. Alternatively, a system of payment that is flexible enough to work with whatever payment system may already be in use at the practice facility. This system would accept debit card, magnetic card, credit card, token, or remote activation.

5. Easy to use touch panel interface for capturing, viewing, and analyzing swings. Most systems today offer separate buttons to draw lines, circles, squares, etc. on the screen. This increases the complexity of the interface for the user. The inventive system includes an intelligent touch panel interface that interprets screen touches to convert to the correct object. For example, if the user draws a circle around the image of his or her head with her finger, the touch screen will receive the input and the software will do pattern identification to approximate a circle under the area the finger touched. This way the user does not need to click different buttons between drawing lines and circles.

6. Ability to compare swings to those of a model or to swings from the same athlete.

7. Ability for the user to store his or her swing to a Flash memory stick for viewing at home or for viewing on future sessions on the system.

8. Network connectivity to the pro shop and to the Internet.

9. Drawing capabilities to add objects to the swing for easier analysis. For example, draw circle around head to see if it shifts or dips.

10. Measurement and display of club head speed through impact.

11. Troubleshooting features to assist the user in solving swing problems. This includes pre-drawn objects to highlight proper swing behavior.

12. Advertising of pro shop merchandise and restaurant food. Offer the services of a pro to come out to the range and give a free introductory swing analysis.

13. Advertising of institutions and products.

14. Ability to order online at the terminal.

15. Professional swing analysis by sending the captured swing directly to the local pro or to a website via the network connection.

16. Provide player tracking for frequent use and offer prize awards.

17. Special consideration for solving image capture at close range, such as stitching images from two cameras together.

18. System of capturing sound using two separate audio-capture devices fixed on the kiosk itself. With this technology the system can accurately calculate the impact point of the club to the ball, despite other interfering noises in the proximity.

19. Security of the system includes a robust mechanical enclosure and installation designed to protect against vandalism and theft.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A video system apparatus for analyzing sports skills, said video system apparatus comprising:
a kiosk portion including a display head with a video display and touch panel interface;
a first video camera connected to said kiosk portion;
a second video camera connected to said kiosk portion; and
means for processing signals from said first and second video camera and displaying a image on said display.

2. The video system apparatus for analyzing sports skills of claim 1 wherein said apparatus includes a payment receptacle to process payment.

3. The video system apparatus for analyzing sports skills of claim 1 wherein said kiosk portion includes a finned extrusion for removing heat from heat-generating components in said kiosk.

4. The video system apparatus for analyzing sports skills of claim 1 wherein said apparatus includes an array microphone to detect the hit of a target ball.

5. The video system apparatus for analyzing sports skills of claim 1 wherein said apparatus includes means for providing advertisements on said video display.

6. The video system apparatus for analyzing sports skills of claim 1 wherein said means for processing signals includes means to correct distortion from lenses.

7. The video system apparatus for analyzing sports skills of claim 1 wherein said kiosk portion includes forced-air cooling of said display head.

8. The video system apparatus for analyzing sports skills of claim 1 wherein said kiosk portion includes a port for insertion of a portable memory device.

9. The video system apparatus for analyzing sports skills of claim 1 wherein said touch panel interface includes a graphical user interface.

10. The video system apparatus for analyzing sports skills of claim 8 wherein said graphical user interface includes geometric sensing techniques.

11. The video system apparatus for analyzing sports skills of claim 1 wherein said touch panel interface includes network connectivity.

12. A method for video recording of an individual performing an activity, said method comprising the steps of:
providing a kiosk portion including a display head with a video display and touch panel interface;
providing a first video camera connected to said kiosk portion; and
providing a second video camera connected to said kiosk portion; and
processing signals from said first and second video camera and displaying a image on said display.

13. The method for video recording of an individual performing an activity of claim 12 further including the step of providing a payment receptacle to process payment.

14. The method for video recording of an individual performing an activity of claim 12 further including the step of removing heat from the heat-generating components in said kiosk with a finned extrusion on the kiosk.

15. The method for video recording of an individual performing an activity of claim 12 further including the step of providing an array microphone in said kiosk to detect the hit of a target ball.

16. The method for video recording of an individual performing an activity of claim 12 further including the step of processing the video signals to correct distortion from fish-eye or other lenses.

17. The method for video recording of an individual performing an activity of claim 12 further including the step of providing a port for a portable memory device.

18. The method for video recording of an individual performing an activity of claim 12 further including the step of providing said touch panel interface with a graphical user interface.

19. The method for video recording of an individual performing an activity of claim 12 further including the step of providing said graphical user interface with geometric sensing techniques.

20. The method for video recording of an individual performing an activity of claim 12 further including the step of providing said touch panel interface with network connectivity.
